(19) United States
(12) Patent Application Publication
(10) Pub. No.: US 2002/0069132 A1
(43) Pub. Date: Jun. 6, 2002

(54) Cross technology monitoring, profiling and predictive caching method and system

(75) Inventors: Ronald M. Perkes, Novato, CA (US); Peter I. Ohtaki, San Francisco, CA (US)

Correspondence Address: Brian J. McNamara, Foley & Lardner, Washington Harbour, 3000 K Street, N.W., Suite 500, Washington, DC, 20007-5109, US

(73) Assignee: LUMENATI, INC.

(21) Appl. No.: 09/994,905

(22) Filed: Nov. 28, 2001

Related U.S. Application Data
(60) Provisional application No. 60/250,152, filed on Dec. 1, 2000.

(51) Int. Cl. G06F 17/60

(52) U.S. Cl. 705/26; 705/10

(57) ABSTRACT

A method of collecting, collating, organizing, analyzing and monetizing information about a consumer's computer usage and the usage of connected peripheral devices, using that information to select, download and coordinate the presentation of Advertising and Viewing Content and a method for the caching and remarriage of Advertising Content and Viewing Content on a consumer's computer. In addition, a method for managing the viewing of that downloaded content by the consumer.

### BACKGROUND OF THE INVENTION

The sweeping transformation to digital entertainment is providing increasing opportunities to advertisers and content providers to expand their viewing markets and make use of content inventory in a non-liner, consumer-targeted manner. These increased opportunities have made room for improved ways to develop information for targeted content distribution, and have opened the doors for improved content delivery and monetization methods.

While development of broadband delivery of Internet-based content is progressing, the field's technological innovations have not reached the point that allows simultaneous real-time downloading and viewing of digitally dense streaming media such as music and video. At the same time, consumer's expectations and demand for delivered digital content is growing, and with the spread of existing broadband delivery systems, will only increase further. In conjunction with this growing need are woefully inadequate methods for delivery of streaming media, with content technology companies chasing after technological answers to increase bandwidth in content delivery systems or further compress content to increase the amount that can be downloaded using current technology. While technological advancement is desired and inevitable, the increasing need in current technology-based broadband delivery makes waiting for these advances unfeasible. It is projected that 74 million broadband-equipped homes and 90 million digital television-equipped homes will be vying for digital content delivery by the year 2008, and the market is open to current technology based delivery of digital content. Currently developed broadband Internet telecommunications are DSL and its related ADSL, XDSL, IDSL (and other derivatives) and cable modems (DOCSIS). These modes of communication are “always on”. However, despite current broadband speeds, Internet congestion creates unreliable speeds and delivery quality. Absent immediate advances in broadband communications technology that expand existing capabilities in ways no one expects, simultaneous real-time delivery and viewing of content is a fact of the distant future.

Currently, consumer profiling is accomplished by either the receipt of information provided by the consumer, or monitoring the consumer's single technology usage, such as Internet, television or radio usage. Accordingly, those limited sources of information restrict the profiling capacity and result in a restricted view of the consumer's media consumption behavior.

In addition, the spread of digital content viewing has created a disconnect in the traditional marriage of advertisers and content providers. Increasing digital content and digital delivery of that content has resulted in the consumer's ability to avoid advertising, either by viewing only non commercial digital content, or skipping advertising via available technologies has driven advertiser's to look for new and more cost effective ways to expose their advertising content and content providers to learn new ways of paying for the creation of their content and monetization of their content inventories.

These factors all combine to intensify the need for new information collection and development, content delivery and content management mechanisms that enable content providers and advertisers to deliver an increased volume of more refined, targeted Advertising and Viewing Content to more consumers using current technology and communications infrastructure, in a manner that is consumer-centered and adaptable to future advances in technology. The method according to the present invention meets all of these criteria and presents an elegant, commercially and technologically feasible and immediate tool for increasing consumer interest in content, content delivery and the multitude of revenue sources that home delivery of content can provide.

### SUMMARY OF THE INVENTION

The present invention is directed to one or more methods of relating to the collecting, collating, organizing, analyzing and monetizing information about a consumer's computer usage and the usage of connected peripheral devices, the use of that information to select, deliver and manage the presentation of Advertising and Viewing Content and a method for the caching, remarriage, and viewing of Advertising Content and Viewing Content on a consumer's computer. The methods fall into several categories, and are controlled by a software program residing on a consumer's computer (the “Client Software”):

Collection of Cross Technology Usage Information.

Upon initiation of the consumer's involvement, the consumer applies to the Exchange Agent to be a participant in the Exchange Agent's membership base, and provides initial information regarding preferences and personal information. With the consumer's consent, continuous monitoring of the consumer's Cross Technology Usage is performed, providing a continuously developing picture of the consumer's viewing, listening and Internet surfing habits over a variety of computer capabilities and connected peripherals. That information (the “collected information”) is collected using the Client Software, which employs standard monitoring and collection techniques and disclosed techniques of information collection regarding the use, existence or non-existence of connected peripherals, components and capabilities.

Profiling and Content Selection.

This method involves the implementation of standard and enhanced profiling and monitoring techniques to determine the interests of a consumer based upon the collected cross-technology information. Based upon the collected information and the categorization of that information, a “profile” of the consumer is developed. This profile is constantly updated and refined based on the consumers' usage. The resulting profile drives the targeted (predictive) selection of Viewing/Advertising Content and E-Commerce opportunities, tailoring them to a consumer's perceived interests.

Network Management.

This method implements collection of selected content links, hard drive management and monitoring tools and content delivery, coordination, caching and presentation functions:

Delivery Scheduler.

In order to accommodate the effects of limited bandwidth and/or general Internet traffic congestion in the downloading process, the present invention is directed to a method or methods, which optimize hard disk space and download scheduling. Through conventional means known to one of ordinary skill in the art, a server or servers which act as the focal point of the content delivery system interrogate the targeted consumer's computer to determine the amount of hard disk space available for downloads. The method gives the consumer the option to select the amount of hard disk space to allocate to the download and select the optimum time for performing the download to minimize interference with the consumers computing activities bandwidth availability, Internet traffic and content server capacity In the alternative, the consumer can allow automatic reservation of hard disk space and timing selection for those downloads. The resulting information is then used to further prioritize the content to be delivered to the point that downloads are configured to optimize space and download scheduling.

Content Manager.

The method or methods of the present invention utilize software residing on the consumer's computer, which manages the display of downloaded content. Downloaded and/or partially downloaded content of different types, such as pay-per-view movies, Internet-delivered video, Internet-delivered digital music, television, Advertising Content and E-Commerce opportunities, are managed and displayed differently. In addition, this method enables the management and caching of content delivered to a consumer's computer from disparate content sources into a seamless, controlled presentation.

Guide.

The method or methods of the present invention provide for the implementation of a Cross Technology Guide to the downloaded content, enabling the consumer to see the downloaded content displayed by the type of content, category or genre, title and other details, such as principal performers, run time and content provider. The guide may even select highlights or small portions of the downloaded video or audio content as “teasers” or “trailers”, to encourage the consumer to view that content. The consumer may pick and choose amongst the provided content and either preview or view the content, save the content for later viewing or delete the content.

The present invention is also directed to one or more methods of establishing, maintaining and receiving revenue from a subscription base or other service type that provides the services provided by the disclosed invention.

### BRIEF DESCRIPTION OF THE DRAWINGS

FIG. 1 is a schematic diagram of the New/Existing User Site Access/Sign On Process used in the present invention.

FIG. 2 is a schematic diagram of Application Process of FIG. 1.

FIG. 3 is a diagram illustrating the Predictive Caching and Content Intermediation Process used in the present invention.

FIG. 4 is a diagram illustrating the Delivery Scheduler Component and Script used in the present invention.

FIG. 5 is a diagram illustrating the Content Manager Component and Script used in the present invention.

### DETAILED DESCRIPTION OF THE PREFERRED EMBODIMENTS

Although the following detailed description contains many specifics for the purpose of illustration, one of ordinary skill in the art will appreciate that many variations and alterations to the following description are with in the scope of the invention. Accordingly, the following preferred embodiment of the invention is set forth without any loss of generality to, and without imposing limitations upon, the claimed invention.

A preferred embodiment of the invention includes a Exchange Agent operating one or more conventional web server machines with standard server software, one or more Advertising Content Providers (who provide only Advertising Content) operating one or more conventional web server machines with standard server software, one or more Viewing Content Providers (providing Viewing Content such as streaming video or music, movies or non streaming media such as e-books or photography) operating one or more conventional web server machines with standard server software. The servers and computer are connected to a computer network, such as the Internet, which enables the servers and computer to communicate with other servers, computers or Internet accessible Appliances via the Internet, Intranets and other networks, standard email, instant messaging and other communication technologies.

In the preferred embodiment of the invention, installed on the Exchange Agent's server or servers, and/or installed on a third party's server or servers and connected to the Exchange Agent's server or servers (or any combination thereof), is appropriate standard server applications and standard and enhanced Internet based monitoring software and profiling software. The Exchange Agent's server or servers, in conjunction with the monitoring and profiling software, operate to collect information about consumers≦ Cross Technology Usage (the “collected information”). As used herein, “Cross Technology Usage” refers to the use by the consumer of not only Internet and Internet delivered video and streaming and downloadable music (such as MP3s), gaming and television capabilities of their computer, but their usage of connected DVD and CD players, high definition television (HDTV) and broadcast television and the usage, existence and/or non-existence of other peripherals and components connected to their computers. The collected information can include the type of digital media the consumer views or listens to (Internet, movies, video, music, DVD, CD, TV/HDTV, etc.) and details about that digital material (i.e., genre, title, run time, artist, etc.), details regarding on-line viewing, such as URLs, on-line purchasing habits, and genre classifications of the consumer's on-line participatory habits, such as contests, advertising involvement and other on-line and interactive TV interactions. In addition, the monitoring software can collect information regarding what peripherals are and are not connected to the consumer's computer.

In addition, the present invention optionally utilizes at the consumer end a computing based Appliance with continuous Internet access, such as a DSL, wireless or Cable connection, but the present invention will accommodate any currently known or anticipated method of Internet connection. The appliance also allows for viewing of television programming, listening to streaming audio via speakers, viewing streaming video on a monitor and listening to CD-ROM or viewing DVD content from a CD-ROM/DVD player. Such a multimedia entertainment center that may be utilized in the present invention as an appliance may be one described in U.S. patent application Ser. No. 09/125,803, entitled MULTIMEDIA COMPUTER AND TELEVISION APPARATUS, which is incorporated in its entirety herein by reference. The appliance has loaded on it the Client Software.

Cross Technology Usage Collection/Profiling.

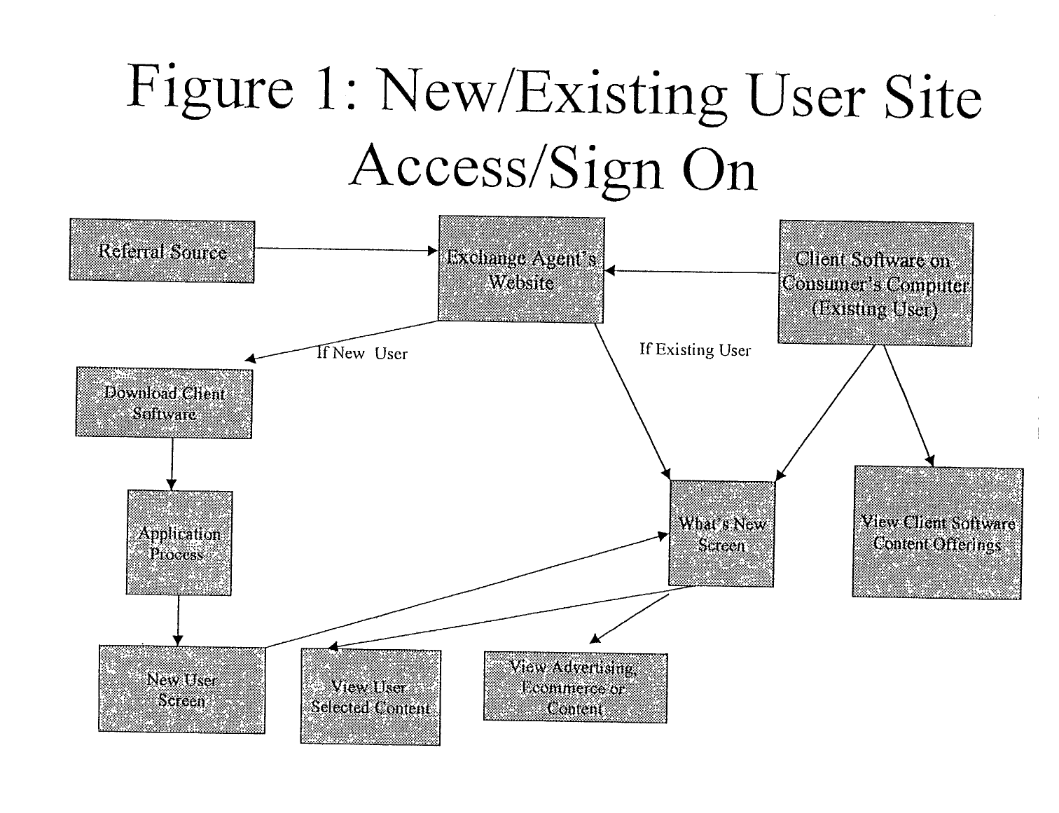

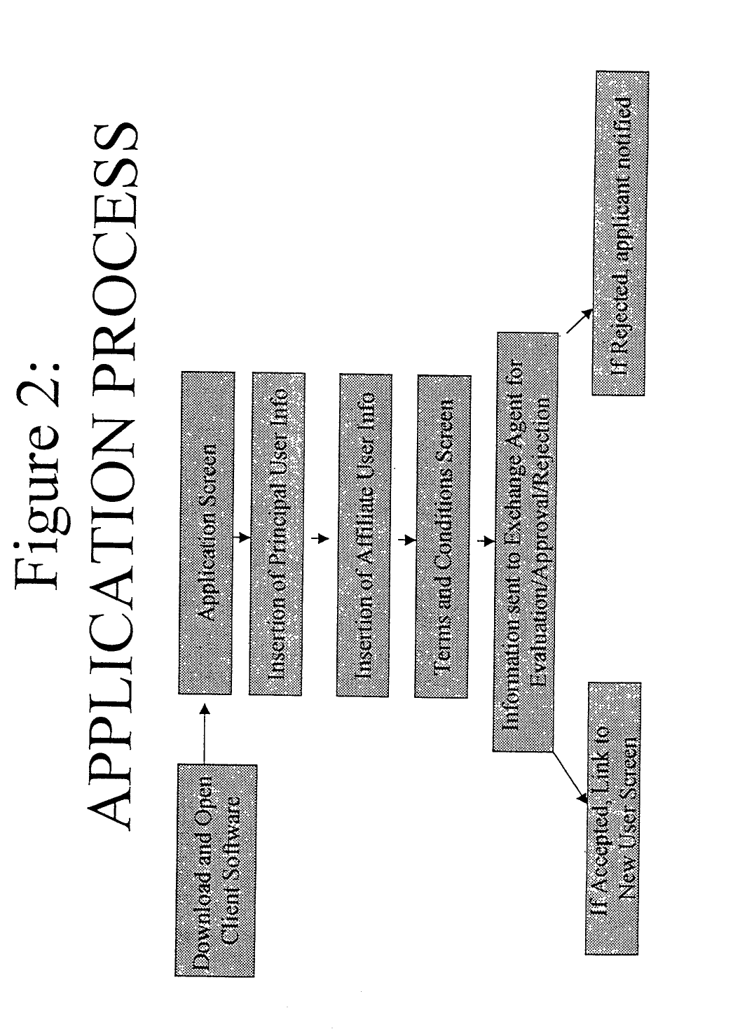

In the present invention, the consumer either receives the Client Software preloaded on a computer or consumer electronics equipment, or downloads the client Software from the Exchange Agent's website. The consumer engages in an application process, whereby the. consumer will provide information such as their geographical location, sex, birthdate and personal interests, and apply to become a Member to the service. Additional information may be collected to further refine the profiling process. FIG. 1 shows a sequence of events relating to a user accessing and/or signing on to the service, according to the invention. FIG. 2 shows the sequence of events of the application process block of FIG. 1. In FIG. 1, if a user is a new user, such as one referred to the exchange agent by a referral source, the user accesses the exchange agent's website and downloads client software. An application process is then executed from the downloaded client software. As shown in FIG. 2, the application process provides an application screen to the user, in which the principal user, as well as any affiliate users, can enter in information used to obtain a “profile” on the user or users. The user is then presented with a “terms and conditions” screen, and the user-provided information is sent to the exchange agent for evaluation. Upon evaluation, the user is either approved or rejected. If approved, the user is provided with a link to a New User Screen; if rejected, the user is notified. Referring back to FIG. 1, an existing user accesses the exchange agent's website via the client software already present on the client's computer. The user can then view client software offerings, as well as “What's New” information provided on a “What's New” screen. The user can view selected content, advertising, of e-commerce information.

The Client Software on the consumer's computer collects, stores and transmits to the Exchange Agent's server or server's information regarding the consumer's Cross Technology Usage. In the present invention, the software takes the form of a Universal Media Player, which acts as a player for all digital entertainment viewed by the consumer. The Universal Media Player obtains logs on the web sites visited by the consumer, whereby the metatags obtained from those web sites are collected to obtain information regarding the types of web sites (e.g., sports, entertainment) the user prefers. The server also logs requests for content from the consumer. A log is also obtained on the television viewing habits of the consumer, by obtaining information obtained from the television signal itself or in combination with a TV-program database, for example, information that indicates the type of programming being watched (that information is also used by a V-chip, and may be encoded in the H-sync or V-sync interval of a television signal). Also, meta data, tags and other meta information embedded in CDs and DVDs played in the DVD/CD ROM Player are logged by the Universal Media Player. Using metatags associated with digital music files, and audio CD track and serial number information in combination with an audio CD database, music listening habits are also logged and the information transmitted to the server or servers. Other types of media that are accessed and played on the cross-media entertainment center may also be obtained and stored in a log, to further refine the profile of the consumer.

The Client Software running on the consumer's computer is designed to enable the consumer to program, store or bookmark favorite TV shows, downloadable/streaming video content, downloadable/streaming music content, video games and other content into sets of personalized preferences that cross the various types of viewing and listening technologies. These bookmarks are also collected and processed in the profiling function, thereby enhancing that function.

Using standard web-based monitoring, logging and collection software, the Exchange Agent's servers collect the collected information via the Internet. On the occasion of the first collection of that information, the information that is collected dates from the consumer's registration with the system. At the time of subsequent collections, the information collected is dated from the most recent previous collection. Collection of information can be done on a regular or irregular basis selected by the consumer or the server software.

The profiling software on the Exchange Agent's server or servers stores advertising, e-commerce and/or content and or content links with metatags, which refer to metadata, contained in the various advertising, E-commerce, content and content links stored on those servers. This metadata may, on all content, include the Title, Content Type, Description and Keywords applicable to that content item. Certain content Items may have additional metadata connected to them. For example, movies may have information regarding the stars and actors in a film, and information regarding director' the existence of sequels, prequals or previous versions or later remakes of the film. Music items may list the artist, album Key Instruments (electric Guitar, piano, strings, etc.). Metadata can be further refined to include, for movies, the movie genre (classical, action, comedy, etc.); or, for music, the genre, chart standing, tempo of the music, decade of release and more subjective items such as beat, voice type and mood. E-commerce and advertising metadata will include purchase transaction information, additional information links, value and desired targeted demographic, among other desired information.

The information collected regarding the consumer's Cross Technology Usage is then categorized according to the content types referred to above, collated and delivered to the profiling software maintained by the Exchange Agent or a third party service. Content items may be part of multiple categories. For example, which processes the information and compares it to one or more databases of content grouped in similar categories and classifications.

The present invention uses the collected information and implements standard and enhanced profiling and monitoring techniques to determine the interests of a consumer. Broadcast television and digital content, including but not limited to streaming video and music, DVD, audio CDs, Advertising Content and E-Commerce opportunities, are categorized into groups of varying degrees of refinement. For instance, sports, movies, music and television may form a first tier set of categories. Further refinement may develop sub categories such as baseball, action movies, and country music and television comedy. Increases in the number of participants in the profiling process permits even further refinement of the groups. In the preferred embodiment of the invention, the profiling groups will be refined to the point where the consumer will be delivered more specific content, such as San Francisco Giants baseball-related content, Bruce Willis action movies, N'Sync music, videos and concerts and original Star Trek television episodes. For example, audio items may be further divided into music, and then into classical, instrumental, pop and other more refined categories. In addition, items can be associated together on a more subjective and flexible basis. For instance, certain advertising (i.e. beer or popcorn commercials) can be associated with sporting events. The collected information and categorized content are processed to select content that meets the consumer's perceived interests (the “selected content”).

A further refinement of the profiling process will also permit the pushing to the consumer of targeted advertising and e-commerce opportunities, and will create a targeted and precisely defined consumer base rich with opportunities for advertising and e-commerce.

Selected content may either be Viewing Content, Listening content, and Advertising Content or E-Commerce opportunities. Selected content may either be based in the Exchange Agent's, Advertiser's or Content provider's servers. In the present invention, the Exchange Agent's servers evaluates the consumer's perceived preferences and, using predictive models, determines content types that might be of interest to the consumer. Selected Content is in the form of links to that content on the content provider's website. The present invention downloads those links to the consumer's computer for management by the Content Manger function of the software on the consumer's computer.

In the present invention, selected content links that are downloaded are managed in several ways as described herein. It may appear as a link, in a preview format, as a full download or as a partial “near on demand” download.The selected content is then further analyzed and narrowed based upon implementation of the Network Management tools disclosed herein. As related to the present invention, the Network Management tools analyze the configuration of the targeted consumer's computer configuration to determine the storage availability based on the extent of available hard drive storage and thus the size of the proposed download. In addition, the present invention analyzes the consumer's Internet access habits and bandwidth availability to determine the best time to schedule a download of the selected content and selected content links. Giving the targeted consumer the ability to set preferences as to the amount of content to be downloaded and the download time are optional features of this method. In addition, the method can be implemented to enable, as an optional function, the automatic evaluation of storage availability and download timing, and to enable the consumer to initiate an immediate download and either storage for future viewing or viewing of the content at the point a sufficient amount of the content is downloaded to ensure a reliable uninterrupted viewing experience.

The Delivery Scheduler Script.

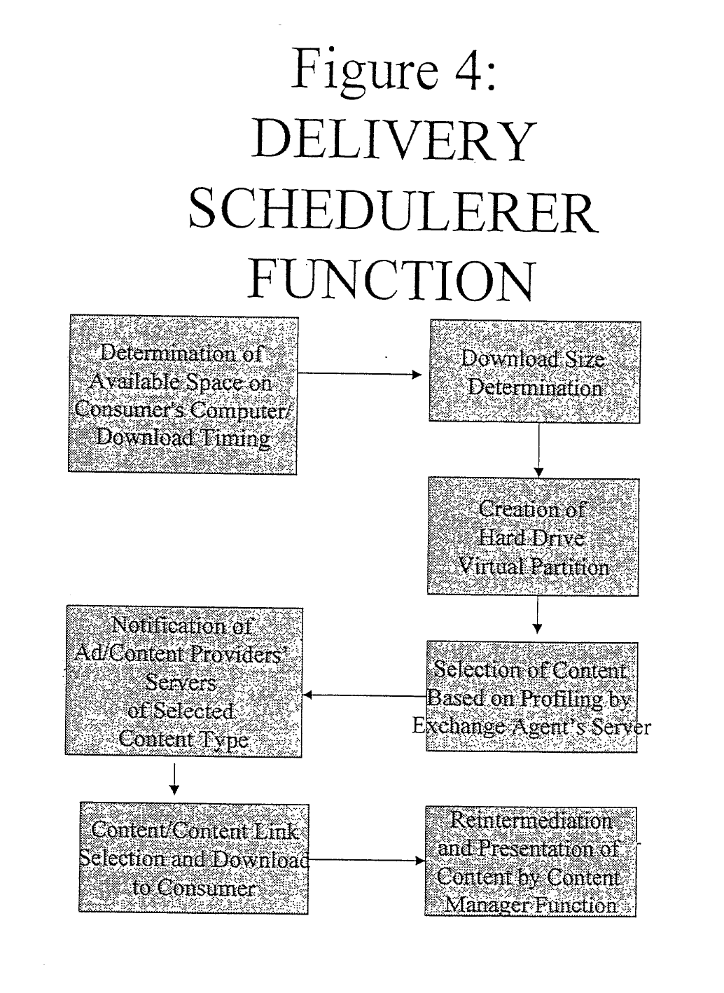

FIG. 4 shows the various steps involved for the Delivery Scheduler function. In the preferred embodiment of the invention, the Delivery Scheduler function software resides on the central server or servers, and is activated at predetermined times to access a particular consumer's computer or a number of consumer's computers. The Delivery Scheduler function determines the amount of free hard disk space on the consumer's computer, and determines the amount of space to allocate to a download to that hard drive using one of two methods. In one method, after being presented with the amount of available hard disk space on the computer, the consumer can select the amount of hard drive space to allocate to receiving delivered content. Using that method, the amount of space available for future downloads will be restricted to the consumer's selected amount. In another method, the consumer allows the Delivery Scheduler function to apply an algorithm to determine a measurement of the size of an acceptable download. That algorithm is: A×B=C, where A is the available hard disk drive space, B is a percentage of that available space determined by the consumers system configuration and considerations related to hard drive performance as it nears full capacity, and C is the acceptable download size.

Based either upon the selection by the consumer or application of the above algorithm, the method then creates a virtual partition of the hard drive or uses any one of several methods to reserve the selected amount of hard drive space, which methods are known to those skilled in the art. This reservation may be fixed for all future downloads or fluctuate (if determined by The Delivery Scheduler function on a download by download basis).

The Delivery Scheduler function then analyzes the selected content links and, using the priority of the consumer's perceived interest in the type and the size of the selected content, eliminates from the download queue lower priority or excessively large content according to the priorities established by the profiling method. For instance, if a consumer has 1.5 gigabits of available hard disk space at the time of the Delivery Scheduler hard drive scan (Algorithm value A), and the value of B is 85%, The Delivery Scheduler function calculates a download size of 1.275 gigabits.

Assume, for example, that the selected content and selected content links are made up of two (2) music videos consisting of 80.5 megabytes, a movie of 970 megabytes, a television episode sized at 255 megabytes and Messaging/Advertising Content/E-commerce opportunities consisting of 120 megabytes (a total of 1.4255 gigabits). The Delivery Scheduler function will first determine if an acceptable download will accommodate downloading all of the selected content and selected content links. In the example, the total download size is 1.4255 gigabits. Since this figure is below the acceptable download calculation (1.5×85%=1.275), The Delivery Scheduler function will first eliminate the lowest priority content item and determine that the balance falls within the acceptable download size. If, after eliminating the lowest priority content, the Delivery Scheduler function determines that the remaining content does not fall within the acceptable download parameters, it will eliminate the next lowest priority content, and continue with this process until the remaining content size is within the acceptable download size.

In the present invention, once the Delivery Scheduler function determines that the remaining content falls within the acceptable download size, it will calculate the difference between the acceptable download size and the actual size of the remaining content. If there is no difference, the Delivery Scheduler function will initiate the download process. If a difference is calculated, the Delivery Scheduler function will go to the previously eliminated content, in priority from the last eliminated to the first eliminated, and recover that content until the difference between the acceptable download size and the actual size of the remaining content is consumed or as nearly consumed as possible in light of the acceptable download size and remaining content. This process ensures that the consumer always receives the largest amount of content in the download.

The Delivery Scheduler function also allows for the delivery to a consumer's computer of updates and improvements to the software that controls the functions of the invention. Such downloads are either done separately so as to maximize the content that can be downloaded, or take priority over content being downloaded.

The Delivery Scheduler function, using the well known functions of the consumer's computer, determines whether the consumer is engaged in using the computer at the time of access and uses the history of recent logged activity and past history stored in the consumers' profile to determine the optimum time for the download and also examines Internet network to determine optimum time when bandwidth is available. An algorithm is applied to this information, which results in a command to either proceed with or delay the download.

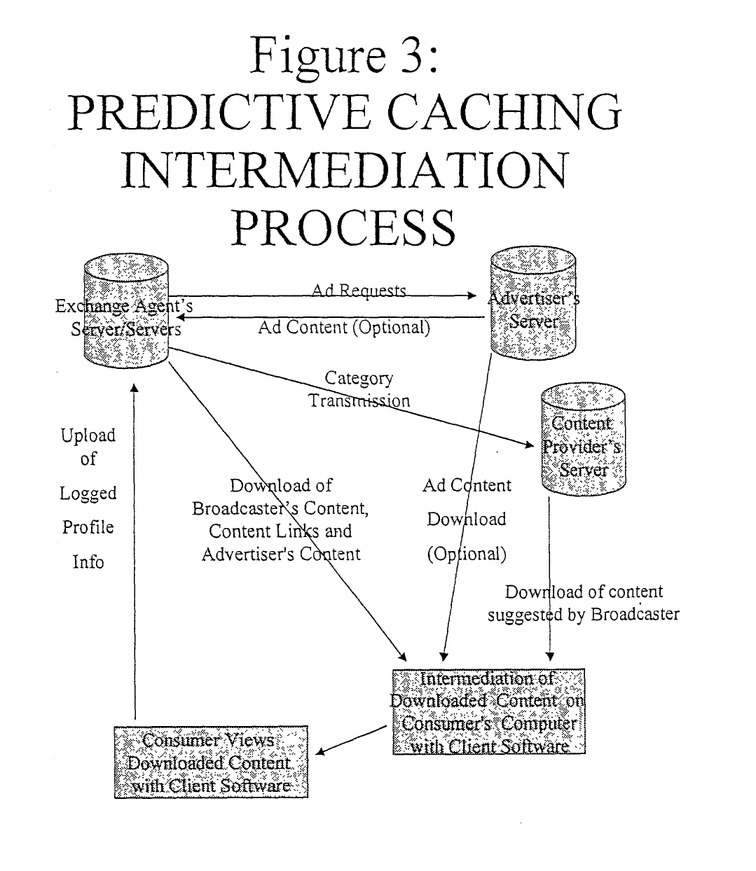

FIG. 3 shows various steps involved in a predictive caching function that may be utilized in the present invention. Predictive Caching, working in combination with The Delivery Scheduler function, is a method of nonlinear digital broadcasting of selected content and content links, the coordination of delivery of that content from disparate sources to, and the organization, control and presentation of selected content and selected content links on, a consumer's computer. Relying on standard and enhanced profiling techniques to select and download to a consumer's computer targeted content and content links from a Exchange Agent's server, the method also enables the Exchange Agent's server or servers to request from Advertiser's servers that Advertising Content that meets the perceived interests of the consumer (see FIG. 3). In addition, the Exchange Agent's server or severs downloads onto the consumer's computer links to Viewing or Listening Content that is perceived to be of interest to the Consumer. Those links are to targeted content from a separate and distinct Viewing Content Providers server. The method instructs the consumer's computer to both download content from the Viewing/Listening Content Provider's server and to organize the delivery of the content from an Exchange Agent's servers and Viewing Content from one or more Content Provider's servers. Once the downloading of all content is complete, the Content manager function organizes the content into a seamless presentation viewable on the consumer's computer in a preselected format.

If the download includes content from disparate servers, The Delivery Scheduler function sequentially requests downloads information from each of those servers to the consumer's hard drive, so that only one server at a time is downloading into the consumer's computer memory. FIG. 3 also shows the consumer providing profile information to the exchange agent server or servers, which is used by that server to determine appropriate ads to sent to the user, as well as content obtained from a content provider's server. The downloaded content and/or ad information is provided to the user by way of the content manager function, which allows the user to view downloaded content by way of the client software.

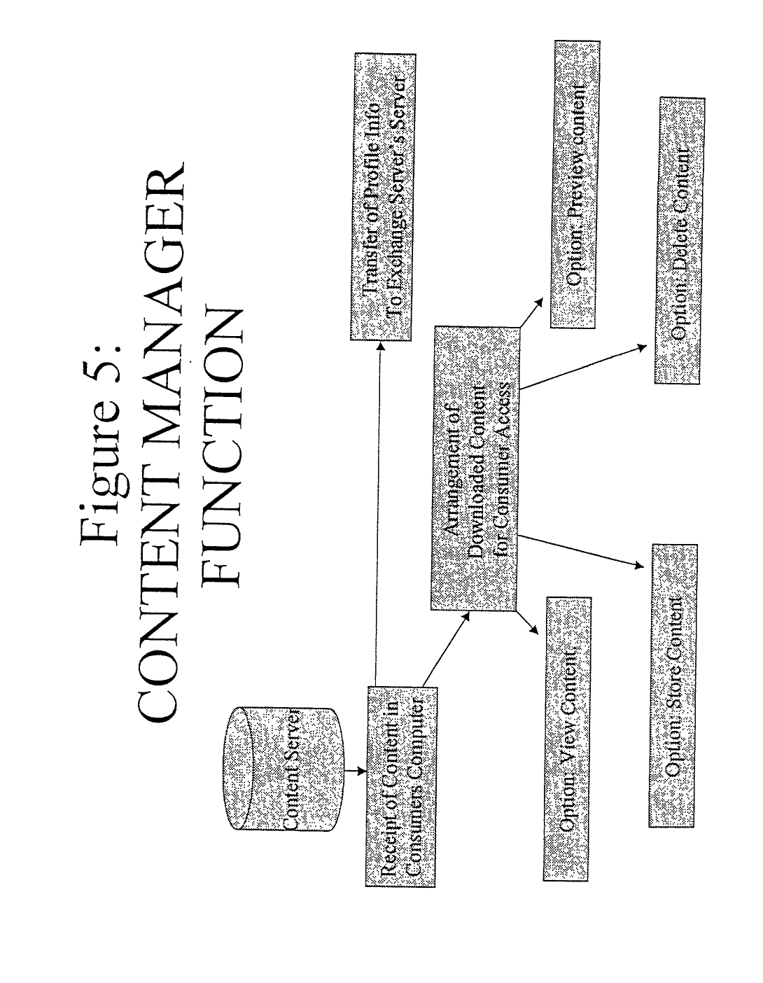

The Content Manager Function. Another component in the preferred embodiment is the Content Manager function. Elements of the Content Manager function are shown in FIG. 5. The content manager function facilitates the receipt, storage and manipulation of the downloaded content once the consumer's computer receives it. This computer function accepts the proceed or delay download command from the Delivery Scheduler function, aggregates the selected content links processed by the profiling software, and initiates the download of that content via the Internet, using widely know methods for downloading of content from one sever on the Internet to another. In addition, the Content Manager notifies any affiliated Content Providers to download their selected content as directed by the results of the profiling process. The Content Manager then stores and organizes the delivered content on the Consumer's hard drive for display.

The content that is downloaded may appear to the consumer in one of several ways. The consumer may be presented with a description of the selected content and a hyperlink which, when clicked on by the consumer mouse or pointing device, directs the consumer's browser to that link, or the selected content may be fully downloaded, in the case of Ad Content or content of a smaller bandwidth. In addition, the consumer may be presented with “near-on-demand” formatted content (the download of a certain portion of lengthy content, such as a pay per view movie or webcast, whose selection to view triggers a showing of the downloaded portion of the content and simultaneous download of the remaining portion of the content or initiates downloading for future viewing). The present invention also enables the presentation of off-line referrals to content (such as concerts DVDs, audio CDs or contests). Referring now to FIG. 5, once the downloaded content has been arranged by the content manager function, the user is provided with several options: a) preview the content, b) view the content, c) store the content, d) delete the content.

The present invention also enables the consumer to view a listing, or guide, of the delivered content accompanied by additional information regarding that content, and to control the viewing of the content, targeted messaging and advertising opportunities. The guide, unlike traditional, single technology, linear guides, displays Cross Technology content opportunities, such as DVD, and CD, CD-Rom, broadcast TV streaming, near-on-demand and on-demand Video, Music, audio, games and any other media capable of being played or displayed on a computer, as well as Advertising Content and E-Commerce opportunities. The guide integrates these disparate technologies into one seamless, digital entertainment guide for all uses.

In the process of the selection of content to be delivered, the Content Manager collects certain data regarding the content (“content data”), including but not limited to the type of content, category or genre, content title and other details, such as principal performers, run time and content provider. Additional content data such as delivery terms may also be collected. For example, content data information regarding a delivered pay-per-view encrypted movie, audio or music video will also include the view terms (pay-per-view price, period in which the content may be viewed, if limited, and time when the content will self delete), or the terms under which the consumer may indefinitely save the content. For example, this method enables copyright owners to place ownership, resale and distribution restrictions on the delivery, much the same as those, which accompany the traditional sale or rental of movies, videos and CDs/DVDs.

These different types of content must be managed differently (i.e. ensuring display perimeters, compliance with encryption guidelines and appropriate deletion of and selected content links once it is viewed or after a specific period of time).

In an embodiment of the invention, the content data is delivered to and formatted by a personalized content guide (PCG). This is a computer program, which collects the content data into a ticker type electronic programming guide format (“guide”), which enables the consumer to review, preview and otherwise customize the manner in which the guide displays the delivered content. The content data is set forth in any one of several formats; the consumer is able to select the desired format from any one of multiple supplied formats. The guide will, on the first download, display the information in a default format, which is the order of the consumer's perceived interest as delivered by The Delivery Scheduler function. When the consumer opens the guide, they will be prompted to review the format of the guide and be given an opportunity to select a default display format, in which case all future guides will be presented in that format. For instance, instead of the priority, or order, in which The Delivery Scheduler function delivers the content, the consumer may want to see all movies displayed first, or all audio selections displayed first. In addition, the method enables the consumer to switch between different formats whenever they are in the guide, whether or not a default format was selected.

The present invention enables the consumer to select one of several ways to view the guide and delivered content. For example, the consumer may choose to view the content displayed in the guide in a different format than the default format and may customize the guide by adding or subtracting categories or genres, and by bookmaking favorite content. The consumer may choose to preview previewable content, immediately view the content, save content that is allowed to be saved, or delete consent of no interest to the consumer. The present invention enables the consumer to preview or view the delivered content, or selected individual items of the delivered content, in any desired order by selecting the appropriate button displayed in the guide in the order the content is to be previewed/viewed. If the consumer makes more hard drive space available, the consumer may also initiate the delivery of lower priority content that was eliminated in the content selection process, in which case the Delivery Scheduler script will begin again as to that content. If the consumer takes no action regarding the content, it will remain on the consumer's computer, to be deleted according to the parameters set forth in the guide. The guide is then used to play whatever content the consumer selects amongst the downloaded content.

Navigation of the guide may be based on consumer-established preferences, profiling, genre/category, recommendation or any combination thereof. The method of navigation may be by traditional means such as keyboard or pointer device, or other means such as voice or 3D, or any method that permits control and selection of displayed items. The Guide may also be “skinnable” where consumers may select many alternative designs.

Depending on the type of content that is delivered, the consumer may be able to “Preview” the content, if previews are provided or allowed by the content provider. This method is implemented by the placing of a “Preview” button on the guide, or distinguishing the content (i.e. displaying the previewable content data in a distinguishing color, in the same manner that the color blue is used to denote a hyperlink on a web page).

The present invention also allows the user to select the content they want to preview or view, and the resulting selection opens a Universal Media Player (UMP). The method integrates the wide variety of media players now available (and can be modified to play future media types), such as streaming video plug-ins (QuickTime, Windows Media Player RealPlayer, etc.), DVD Player, TV/HDTV player and streaming music players (MP3) into what appears to the consumer as an integrated user interface with consistent navigation metaphors and controls (such as play, stop, forward, favorites, etc.). The consumer's selection is automatically detected and opens the media player required to play the type of media selected. If the Consumer activates the particular method implemented, the Guide will launch either a proprietary media player or any one of several widely distributed and well-known media player formats (such as Windows Media Player, RealPlayer or Apple's QuickTime Media Player), and display the preview of the content. For instance, if the content is a movie or video, the guide might play highlights of that content or a content provider supplied movie/video trailer may be shown. If the content is audio content, the guide might play highlights of the content, such as a portion of a musical piece or speech. These “teasers” would be used to encourage the consumer to play the previewed content, thereby increasing pay per views.

The present invention enables the Exchange Agent to deliver to the consumer additional content in the form of messages, Advertising Content and E-Commerce opportunities. Messages may contain such information regarding targeted announcements of deliverable content or E-Commerce opportunities, previews of available deliverable content, contest opportunities, upcoming events and e-commerce opportunities. Advertising Content and E-Commerce opportunities may also appear. Targeted messages are those that are have perceived interest to the consumer. Targeted announcements are more likely to be viewed by consumers, thereby increasing the chances of action taken by the consumer (i.e. purchase of pay per view content, viewing of ads, engaging in e-commerce). In addition, the method allows for the delivery of announcements about the service itself. For instance, The Delivery Scheduler function may initiate a notice that there is not enough drive space to deliver content at the next scheduled delivery, advising the consumer to make additional hard disk space available. The message may also make announcements of events such as software upgrades, new features and feature improvements and new content partners.

Use of targeted content delivery can result in both targeted delivery of Viewing Content (such as pay-per-view movies, music and other media) and Advertising content. For instance, the delivery of targeted Advertising Content to be viewed, the delivery of targeted e-commerce opportunities (on- or off-line opportunities to purchase products and services), and consumer participation activities (such as contests, drawings and other activities requiring more consumer involvement), in addition to all other standard methods for monetizing targeted audiences, can be implemented using standard techniques and the methods described herein to develop revenue sources.

While the present invention has been described with respect to preferred embodiments, other types of configurations may be possible, while remaining within the spirit and scope of the present invention, as exemplified by the following claims.

What is claimed is:

1. A method for the collection and storing of Cross Technology information, comprising:
collecting information regarding a consumer's use of a computer and the consumer's use of any connected peripherals to the computer,
wherein the collected information is used to provide content choices to the consumer to select content from the Internet by way of the computer, and to select available content from any one of the connected peripherals.

2 A method according to claim 1, further comprising:
allowing the consumer to bookmark favorite Cross Technology Media as part of the collected information.

3. A method according to claim 1, further comprising:
providing the collected information to a central server or servers for processing of the collected information and for sending content choices back to the computer for selection by the consumer.

4. A method according to claim 1, further comprising:
comparing the collected information of the consumer to a set of categories of content to establish a profile of the consumer.

5. A method according to claim 4, further comprising:
refining the profile of the consumer based on an amount of collected information obtained from the consumer.

6. A method according to claim 3, further comprising:
comparing the profile of the consumer with available content and selecting content that meets perceived interests of the consumer based on the profile of the consumer.

7. A method according to claim 3, further comprising:
comparing the profile of the consumer with available content and selecting advertising content that meets perceived interests of that individual consumer based on the profile of the consumer.

8. A method according to claim 3, further comprising:
comparing the profile of the consumer with available content and selecting E-commerce opportunities that meets perceived interests of that individual consumer based on the profile of the consumer.

9. A method of providing content to a computer of a user, comprising:
selecting, by the user, an amount of hard drive space to be made available for downloads of content to the computer.

10. A method according to claim 9, further comprising:
determining the amount of hard drive space to be made available for downloads of content to the computer by using an algorithm.

11. A method according to claim 10, further comprising:
reserving the amount of hard drive space to be used only for content to be downloaded to the computer.

12. A method according to claim 9, further comprising:
determining an optimum time of day to perform the downloads of the content to the computer.

13. A method according to claim 9, further comprising:
determining which of a plurality of selected content are to be downloaded based on an algorithm, the size of each of the corresponding content input from each of the selected content links, and priorities established based on perceived interests of the user.

14. A method of coordinating the downloading of different content from separate and distinct servers to a targeted consumer's computer.

15. A method according to claim 14, further comprising:
organizing the downloading of the different content from the separate and distinct servers to the consumer's computer as a seamless presentation of content.

16. A method of downloading content from a server computer to a client computer, comprising:
downloading a portion of the content from the server computer to the client computer;
viewing the portion of the content by a user at the client computer; and
simultaneous with the viewing of the portion of the content, downloading a remaining portion of the content to the client computer.

17. A method of displaying cross technology content for a multimedia entertainment system, comprising:
displaying content information regarding the content available for each media element of the multi-media entertainment system in a guide-like format on a display of the multi-media entertainment system.

18. A method according to claim 17, further comprising:
displaying the content information in a manner modifiable by a user.

19. A method according to claim 18, further comprising:
displaying the content information in a manner that allows the user to preview, view, save for later viewing, or delete a particular portion of the content information.

20. A method according to claim 18, further comprising:
allowing for the delivery of copyright-protected content in a manner consistent with a Content Provider's requirements for payment, viewing and storage of the copyright-protected content.

21. A method according to claim 17, further comprising:
displaying the content information by displaying the content information on a display of the multi-media entertainment system.

22. A method according to claim 17, further comprising:
displaying the content information in a manner that provides teasers concerning content listings.

23. A method according to claim 17, further comprising:
displaying the content information so as to provide a consumer with content data regarding the displayed content information.

24. A method of displaying Cross Technology Content on a display of a monitor of a multi-media entertainment system, comprising:
providing the content as a guide on the display;
allowing a user to navigate the guide using a keyboard, by a pointer device, or by voice activation, or by 3-D or animated display of the guide;

25. A method according to claim 24, further comprising:
allowing the consumer to play the selected content from the guide in a Universal Media Player format, which appears as an integrated interface with consistent navigation metaphors and controls.

26. A system for displaying Cross Technology Content for a multimedia entertainment system, comprising:
a display that provides the content as a guide for selection of at least one of a plurality of multi-media programs; and
means for allowing a user to navigate the guide and to select one or more of the plurality of multi-media programs for playing on the multimedia entertainment system.
